(19) United States
(12) Patent Application Publication
(10) Pub. No.: US 2020/0077215 A1
(43) Pub. Date: Mar. 5, 2020

(54) FIBER MOLDED PRODUCT, FIBER MOLDING DEVICE, AND MANUFACTURING METHOD OF FIBER MOLDED PRODUCT

(71) Applicant: SEIKO EPSON CORPORATION, Tokyo (JP)

(72) Inventor: Tsukasa OTA, Kofu (JP)

(21) Appl. No.: 16/551,881

(22) Filed: Aug. 27, 2019

(30) Foreign Application Priority Data
Aug. 29, 2018 (JP) 2018-160220

(51) Int. Cl. H04R 31/00; B29C 43/00; B29C 43/02; B29C 43/36; B29C 33/42; B29C 43/58

(52) U.S. Cl. CPC H04R 31/003; B29C 43/003; B29C 43/027; B29K 2069/00; B29C 33/42; B29C 43/58; B29C 43/36

(57) ABSTRACT

A vibration plate manufacturing device includes: a defibration unit which defibrates a material including fibers and generates a defibrated material formed of fibers having a fibril area of 0.5% to 2.0%; a mixing unit which mixes a binding material for binding the fibers to each other, into the defibrated material; a second web formation unit which accumulates a mixture mixed by the mixing unit; and a molding unit and a heating unit which perform a molding process including pressing and heating on the second web to obtain a molded product.

The present application is based on, and claims priority from JP Application Serial Number 2018-160220, filed Aug. 29, 2018, the disclosure of which is hereby incorporated by reference herein in its entirety.

### BACKGROUND

### 1. Technical Field

The present disclosure relates to a fiber molded product, a fiber molding device, and a manufacturing method of a fiber molded product.

### 2. Related Art

In the related art, a method of molding fibers by wet papermaking is known (for example, see JP-A-4-23597). JP-A-4-23597 discloses a method of papermaking microfibrillated cellulose by using a papermaking screen and manufacturing an acoustic vibration plate. In JP-A-4-23597, a reinforcing member is disposed on the papermaking screen, in order to cope with an excessive decrease in strength in a wet state during the papermaking and damages due to an increase in beating degree of cellulose.

### SUMMARY

An object of the present disclosure is to suppress cracks or wrinkles during the process of molding fibers and efficiently manufacture fiber molded product.

According to an aspect of the present disclosure, there is provided a fiber molded product, including: a defibrated material obtained by defibrating a material including fibers; and a binding material for binding the fibers to each other, in which the fiber molded product is three-dimensionally molded by a molding process including pressing and heating, and the defibrated material is formed of fibers having a fibril area of 0.5% to 2.0%.

In the fiber molded product, the binding material may include a thermoplastic resin.

According to another aspect of the present disclosure, there is provided a fiber molding device including: a defibration unit which defibrates a material including fibers and generates a defibrated material formed of fibers having a fibril area of 0.5% to 2.0%; a mixing unit which mixes a binding material for binding the fibers to each other, into the defibrated material; an accumulation unit which accumulates a mixture mixed by the mixing unit; and a molding unit which performs a molding process including pressing and heating on an accumulated material accumulated by the accumulation unit to obtain a molded product.

In the fiber molding device, the binding material may include a thermoplastic resin.

In the fiber molding device, the molding unit may press the accumulated material pinched using a press die.

In the fiber molding device, a surface roughness of the press die may be equal to or smaller than an average fiber width of the fibers included in the defibrated material.

In the fiber molding device, the molding unit may perform the heating at a temperature equal to or higher than a glass transition temperature of the binding material.

In the fiber molding device, the molding unit may perform the heating at the temperature equal to or higher than the glass transition temperature of the binding material and equal to or lower than a melting point of the binding material.

The fiber molding device may further include a humidity controlling unit which controls humidity of the mixture.

The fiber molding device may further include a sheet molding unit which presses and heats the accumulated material accumulated by the accumulation unit to form a sheet, in which the molding unit may perform on the sheet the molding process including heating at a temperature higher than that in the sheet molding unit.

The fiber molding device may further include: a cutting unit which cuts the accumulated material to be transported to the molding unit at a position upstream from the molding unit in a transport direction of the accumulated material; and a control device which detects a transported amount of the accumulated material to be transported to the molding unit, and operates the cutting unit based on the transported amount and a unit amount of the molding process of the molding unit.

According to still another aspect of the present disclosure, there is provided a manufacturing method of a fiber molded product, the method including: defibrating a material including fibers to generate a defibrated material formed of fibers having a fibril area of 0.5% to 2.0%; mixing a binding material for binding the fibers to each other, into the defibrated material; accumulating the mixture; and performing a molding process including pressing and heating on the accumulated material to obtain a molded product.

### BRIEF DESCRIPTION OF THE DRAWINGS

FIG. 1 is a perspective view of a vibration plate of a first embodiment.

FIG. 2 is a schematic view of components configuring a vibration plate.

FIG. 3 is a flowchart showing a manufacturing method of the vibration plate of the first embodiment.

FIG. 4 is a configuration view of a vibration plate manufacturing device of the first embodiment.

FIG. 5 is a perspective view of a molding die.

FIG. 6 is a flowchart showing an operation of a vibration plate manufacturing device.

FIG. 7 is a flowchart showing a manufacturing method of a vibration plate of a second embodiment.

FIG. 8 is a configuration view of a vibration plate manufacturing device of the second embodiment.

FIG. 9 is a flowchart showing a manufacturing method of a vibration plate of a third embodiment.

FIG. 10 is a configuration view of a vibration plate manufacturing device of the third embodiment.

### DESCRIPTION OF EXEMPLARY EMBODIMENTS

Hereinafter, preferred embodiments of the present disclosure will be described in detail with reference to the drawings. The embodiments described below do not limit the contents of the present disclosure disclosed in the aspects. In addition, all of the configurations described below is not necessarily compulsory constituent elements of the present disclosure.

### 1. First Embodiment

1-1. Configuration of Speaker Vibration Plate

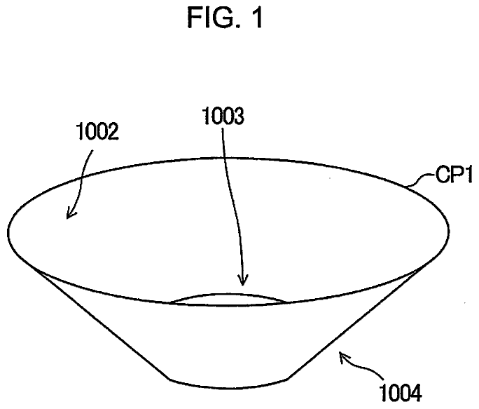

FIG. 1 is a perspective view of a vibration plate CP1 of a first embodiment.

The vibration plate CP1 is an example of a fiber molded product and is a vibration plate used in a speaker which outputs sound. The vibration plate CP1 has a truncated cone shape and is subjected to a process of attaching an edge, a center cap, a lead wire, or a voice coil to configure a speaker. In the description hereinafter, the vibration plate CP1 will be described to have a simple truncated cone shape, but a concentric ribs may be provided on the vibration plate CP1. In addition, on an outer peripheral portion of the vibration plate CP1, a shape for attaching an edge may be provided or a shape for attaching a lead wire or a center cap may be provided.

The vibration plate CP1 is formed by pressing and heating a material including fibers, as will be described later. The vibration plate CP1 has a recessed surface on a side for outputting sound. In the vibration plate CP1, a front surface on a side for outputting sound is set as 1002, and a bottom surface portion of the recess of the front surface 1002 is set as a bottom portion 1003. In addition, the surface on a rear side of the front surface 1002 is set as a rear surface 1004.

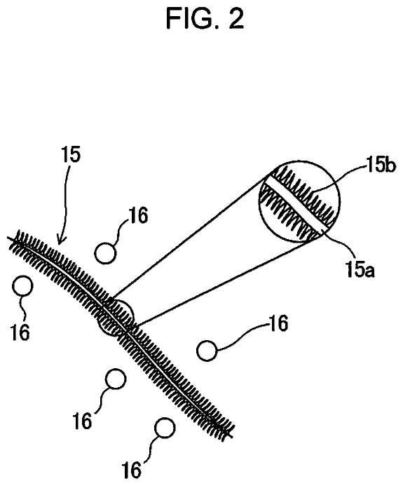

FIG. 2 is a schematic view of components configuring the vibration plate CP1, which is partially illustrated in the circle in an enlarged manner.

A reference numeral 15 is a fiber configuring the vibration plate CP1, and a reference numeral 16 is a particle of a resin as a binding material for crosslinking the fibers 15 and binding the fibers to each other.

As will be described later, fibers 15 are fibers obtained by defibration of a raw material MA. The raw material MA may be any material, as long as it includes fibers. For example, a wood-based pulp material, kraft pulp, waste paper, or synthetic pulp can be used. Examples of the wood-based pulp include mechanical pulp manufactured by a machine process such as ground pulp, chemical pulp manufactured by a chemical process, and semi-chemical pulp or chemiground pulp manufactured by using both of these processes in combination. In addition, any of bleached pulp or unbleached pulp may be used. For example, virgin pulp such as softwood bleached kraft pulp (N-BKP) or broad-leaved tree bleached kraft pulp (L-BKP), or Bleached ChemiThermoMechanical Pulp (BCTMP) is used. Nano-cellulose fibers (NCF) may be used. The waste paper is used paper such as plain paper copy (PPC) after printing, magazines or newspaper. As the synthesis pulp, SWP manufactured by Mitsui Chemicals, Inc. is used, for example. SWP is a registered trademark.

The fiber 15 is a cellulose fiber. The fiber 15 is fibrillated by a process of defibrating the raw material MA in the atmosphere. As shown with the enlarged drawing, in the fiber 15, fine nap 15b is formed on a surface of a cellulose fiber 15a by being fibrillated.

The fiber 15 is preferably a fiber having a fibril area of 0.5% to 2.0%. The fibril area is an area of fine nap of the fiber 15 and can also be set as fine fluff area. For example, the measurement thereof is performed by “L&W fiber tester Code 912+” manufactured by ABB.

The resin 16 is a resin which functions as a binding material for binding fibers to each other and is, for example, a thermoplastic resin.

As the thermoplastic resin, a resin having a glass transition temperature Tg equal to or higher than 70° C. and a melting point equal to or lower than 150° C. can be used. As specific examples of the thermoplastic resin, a petroleum-derived resin, a biomass plastic, or a biodegradable plastic can be used. Here, examples of the petroleum-derived resin include a polyolefin resin, a polyester resin, a polyamide resin, polyacetal, polycarbonate, modified polyphenylene ether, cyclic polyolefin, an ABS resin, polystyrene, polyvinyl chloride, polyvinyl acetate, polyurethane, Teflon, an acrylic resin, polyphenylene sulfide, polytetrafluoroethylene, polysulfone, polyether sulfone, amorphous polyaryate, liquid crystal polymer, polyetheretherketone, thermoplastic polyimide, and polyamideimide. Examples of the biomass plastic or the biodegradable plastic include polylactic acid, polycaprolactone, modified starch, polyhydroxybutyrate, polybutylene succinate, and polybutylene succinate adipate. Teflon is a registered trademark. Examples of the thermosetting resin include a phenolic resin, an epoxy resin, a vinyl ester resin, and unsaturated polyester. When the fiber 16 is particles, particles having a weight average particle diameter of 0.1 μm to 120 μm are more preferable, and particles having 1 μm to 50 μm are even more preferable.

The fiber 15 and the resin 16 are in a state where the resin 16 is attached to the fiber 15 by the mixing performed in a mixing step which will be described later. When this mixture is heated, the resin 16 is softened, and the fiber 15 and the other fiber 15 are crosslinked. Accordingly, a strength is exhibited by the binding between the fibers 15 due to the resin 16, and a shape of the fiber molded product can be maintained.

1-2. Manufacturing Step of Speaker Vibration Plate

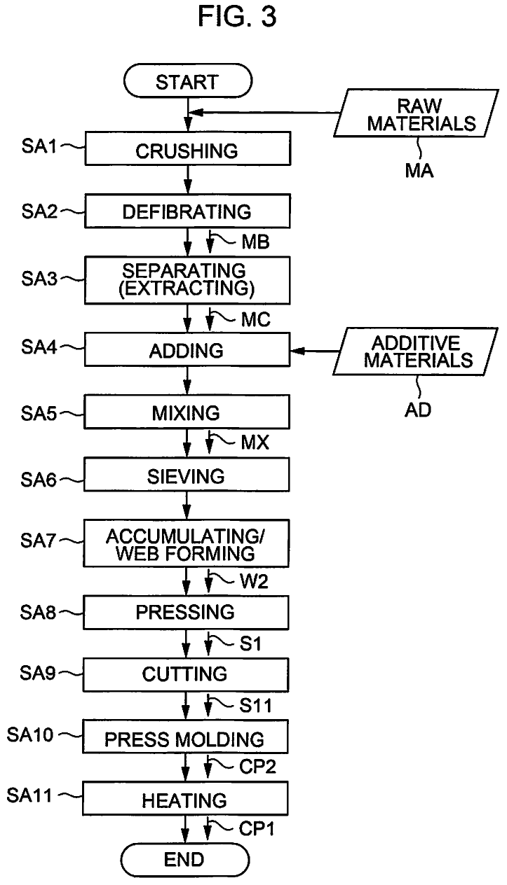

FIG. 3 is a flowchart showing a manufacturing method of a vibration plate of the first embodiment and shows a step of manufacturing the vibration plate CP1 from the raw material MA.

Step SA1 is a crushing process of crushing the raw material MA. The crushing process is a step of cutting the raw material MA to have a size equal to or smaller than a predetermined size. The predetermined size is, for example, 1 cm to 5 cm square. The cut raw material MA is a crushed piece. When the raw material MA is configured of fibers or a fiber piece having a size equal to or smaller than the predetermined size, the crushing step in Step SA1 may be omitted.

Step SA2 is a defibration step. The defibration step is a step of defibrating the raw material MA or the crushed piece crushed in Step SA1 in an atmosphere, to disentangle the fibers included in the raw material MA to one or a several number of fibers. The raw material MA and the crushed piece can also be referred to as a material to be defibrated. In addition, a material defibrated in the defibration step is a defibrated material MB. By defibrating the raw material MA in the defibration step, an effect of separating a substance such as resin particles, an ink, a toner, or a bleeding inhibitor attached to the raw material MA from the fibers can be expected. The defibrated material MB may include resin particles, a colorant such as an ink or a toner, or an additive such as a bleeding inhibitor or a paper strengthening agent, which is separated from the fibers in disentangling of the fibers, in addition to the disentangled defibrated material fibers.

In the defibration step, the defibration is performed by a dry method. The dry method indicates a process of defibrating or the like performed not in a liquid, but in the atmosphere or the controlled gas.

In addition, in the process described below, the process performed in the atmosphere is not limited to a process performed in the air. For example, the process can also be performed in gas other than the air. That is, the expression “in the atmosphere” described below can be replaced with “in gas”.

The defibrated material MB may include fibers having different lengths. A length of the fiber included in the defibrated material MB, that is, a fiber length is preferably 1 μm (1.0×10⁻⁶ m) to 500 mm and more preferably 5 μm to 200 mm. A thickness of the fiber, that is, a fiber diameter is preferably 0.1 μm to 1,000 μm and more preferably 1 μm to 500 μm.

Step SA3 is a step of extracting a material mainly including the fibers from the defibrated material MB, and is referred to as a separation step. The separation step is a step of separating particles such as a resin or an additive from the defibrated material MB including fibers or a resin, and extracting the material mainly including the fibers. Accordingly, particles of a resin or an additive affecting the manufacturing of the vibration plate CP1 can be removed from the components included in the raw material MA. The material separated in the separation step is set as a material MC.

When the raw material MA supplied in Step SA1 does not include the particles or the like affecting the manufacturing of the vibration plate CP1, or when it is not necessary to remove the particles or the like from the component included in the raw material MA, the separation step in Step SA3 can be omitted. In such a case, the defibrated material MB is used as the material MC as it is.

Step SA4 is an addition step. The addition step is a step of adding an additive material AD to the material (material including fibers as a main component) MC separated in Step SA3.

The additive material AD may include a resin 16 as the binding material. The additive material AD may include a thermally expandable material which expands by heating, in addition to the resin 16. As the thermally expandable material, a so-called foaming material can be used. The thermally expandable material is preferably particles, and a thermally expandable material molded in a particulate state can be referred to as a foaming particles. A particle diameter of the foaming particles included in the additive material AD is preferably 0.5 μm to 1,000 μm and more preferably 1 μm to 300 μm, in terms of an average particle diameter before foaming. The average particle diameter before foaming is even more preferably 5 μm to 1,000 μm and most preferably 5 μm to 800 μm.

As the foaming particles, a capsule type thermally expandable capsule which expands by heating, or foaming material mixed particles mixed with the thermally expandable material can be used. Examples of the thermally expandable capsule include ADVANCELL manufactured by Sekisui Chemical Co., Ltd., KUREHA Microsphere manufactured by Kureha Corporation, Expancel manufactured by Akzo Nobel, and Matsumoto Microsphere manufactured by Matsumoto Yushi-Seiyaku Co., Ltd. ADVANCELL, KUREHA, Expancel, and Matsumoto Microsphere are all registered trademarks. The foaming material mixed particles are a particulate preparation prepared by mixing the thermally expandable material with the thermoplastic resin. Here, as the foaming material, azodicarbonamide, N,N′-dinitrosopentamethyl enetetramine, 4,4′-oxybis (benzenesulfonyl hydrazide), N,N′-dinitrosopentamethylenetetramine, azodicarbonamide, and sodium hydrogen carbonate can be used. When surfaces of the foaming particles are coated with the resin, a coverage of the foaming particles with the resin is preferably 10% to 100%.

The additive material AD may include an inorganic filler, hard fibers, and thixotropic fibers, as a reinforcing material for rigidifying of a crosslinked bound structure, in addition to the resins described above. As the inorganic filler, calcium carbonate, mica, or the like can be used, for example. As the hard fibers, carbon fibers, metal fibers, or the like can be used, for example. As the thixotropic fibers, cellulose nano-fibers are used.

In addition, the additive material AD may be formed as a composite resin material powder, by kneading and pulverizing the components such as the resins, the foaming particles, or the reinforcing materials.

Step SA5 is a mixing step. In the mixing step, the material MC and the additive material AD are mixed with each other to prepare a mixture MX.

Step SA6 is a sieving step. In the sieving step, the mixture MX is sieved, dispersed in the atmosphere by an air-laid method, and is dropped.

Step SA7 is an accumulation step. In the accumulation step, the mixture MX dropping in the sieving step in Step SA6 is accumulated and a web is formed. The web formed in Step SA7 is referred to as a second web W2. The second web W2 is a state where the fibers and the additive material AD included in the mixture MX are accumulated, has a predetermined thickness, and has a low rigidity and a low density. The second web W2 corresponds to the accumulated material and the web.

Step SA8 is a pressing step of pressing the second web W2. In the pressing step, the second web W2 is pressed, and a sheet S1 is formed.

Step SA9 is a cutting step of cutting the sheet S1 formed in the pressing step to have a size of a molding die, and forming a cut sheet S11.

Step SA10 is a press step of pressing the cut sheet S11 pinched between the molding die. In the press step, the cut sheet S11 is processed in a shape of the molding die to be a plate-shaped fiber body CP2.

Step SA11 is a heating step. In the heating step, the plate-shaped fiber body CP2 is heated. In the heating step, the resins 16 included in the plate-shaped fiber body CP2 are softened or dissolved to crosslink the fibers 15 and bind the fibers 15 to each other, and accordingly, the vibration plate CP1 is formed.

In the pressing step in Step SA8, the pressure applied to the second web W2 is preferably a pressure lower than a pressure applied to the cut sheet S11 in the press step in Step SA10. For example, the pressure in the pressing step can be 0.1 kg/m² to 100 kg/m². The second web W2 is, for example, processed into the sheet S1 having a thickness of 1 mm to 10 mm in the pressing step. Meanwhile, the pressure in the press step can be 0.1 t (1.0×10² kg)/m² to 15 t/m². In the press step, the cut sheet S11 is processed into the plate-shaped fiber body CP2 having a thickness of 0.1 mm to 5 mm, for example.

A heating temperature of the heating step in Step SA11 is preferably a temperature equal to or higher than a glass transition temperature Tg of the resin 16 and more preferably equal to or lower than the melting point of the resin 16. The heating temperature is most preferably equal to or higher than the glass transition temperature Tg of the resin 16 and equal to or lower than the melting point. As described above, in a case of using the binding material having a glass transition temperature Tg equal to or higher than 70° C. and a melting point equal to or lower than 150° C., the heating temperature in Step SA11 can be 130° C. to 150° C., and the heating temperature may reach 200° C.

1-3. Configuration of Vibration Plate Manufacturing Device

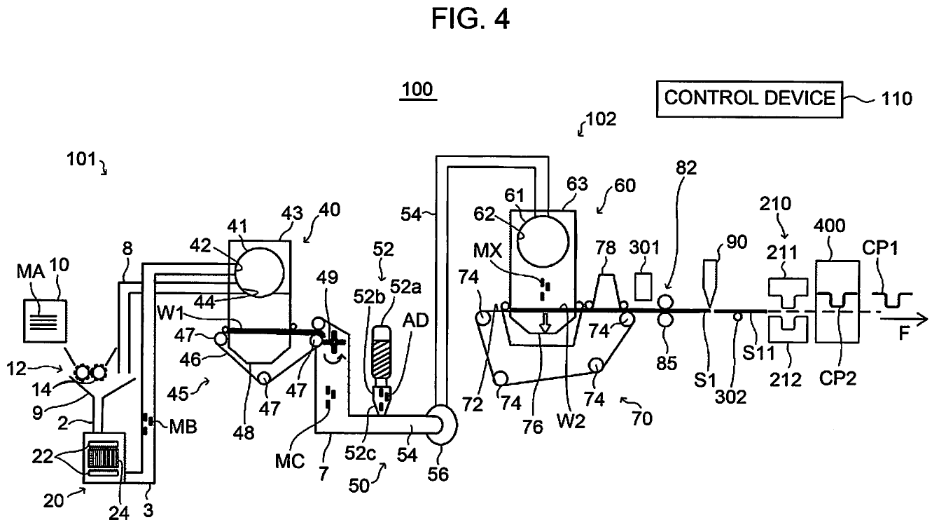

FIG. 4 is a configuration view of a vibration plate manufacturing device 100.

The vibration plate manufacturing device 100 is an example of a device which performs a manufacturing step of the vibration plate CP1 shown in FIG. 3, and manufactures the vibration plate CP1 from the raw material MA.

The vibration plate manufacturing device 100 corresponds to a fiber molding device.

The vibration plate manufacturing device 100 includes a defibration unit 20, an additive material supply unit 52, a mixing unit 50, a second web formation unit 70, and a molding unit 210, as a compulsory configuration. In addition, the vibration plate manufacturing device 100 includes a supply unit 10, a crushing unit 12, a selection unit 40, a first web formation unit 45, a rotator 49, the mixing unit 50, a dispersion unit 60, a web transport unit 79, a pressing unit 82, a cutter 90, the molding unit 210, and a heating unit 400.

The crushing unit 12, the defibration unit 20, the selection unit 40, and the first web formation unit 45 configure a defibration processing unit 101 which manufactures the material MC by processing the raw material MA. The rotator 49, the mixing unit 50, the dispersion unit 60, the second web formation unit 70, the pressing unit 82, and the cutter 90 configure a manufacturing unit 102 which manufactures the sheet S1 and the cut sheet S11 from the material MC.

The vibration plate manufacturing device 100 includes a control device 110 which controls each unit of the vibration plate manufacturing device 100. A sheet detection unit 301 and a rotary encoder 302 are coupled to the control device 110. The control device 110 is, for example, a computer which includes a processor executing a program and a memory device which stores programs or setting data, and controls each unit of the vibration plate manufacturing device 100 by the processor.

The supply unit 10 is an automatic insertion device which accommodates the raw material MA and continuously inserts the raw material MA to the crushing unit 12.

The crushing unit 12 includes a crushing blade 14 and cuts the raw material MA by the crushing blade 14 in the atmosphere to obtain a crushed piece having a size of several cm square. A shape or a size of the strip is random. As the crushing unit 12, a shredder can be used, for example. A process of the crushing unit 12 corresponds to the crushing step (Step SA1). The raw material MA cut by the crushing unit 12 is collected by a hopper 9 and transported to the defibration unit 20 through a tube 2.

The defibration unit 20 is a device which defibrates the crushed piece cut by the crushing unit 12 by a dry method, and performs the defibration step (Step SA2). The defibration unit 20 can be configured of a defibration machine such as an impeller mill, for example. The defibration unit 20 of the embodiment is a mill which includes a cylindrical stator 22 and a rotor 24 rotating in the stator 22, and in which a defibration blade is formed on an inner peripheral surface of the stator 22 and an outer peripheral surface of the rotor 24. By the rotation of the rotor 24, the crushed piece is pinched between the stator 22 and the rotor 24 and defibrated. The defibrated material MB obtained by the defibration by the defibration unit 20 is sent to a tube 3 from an outlet of the defibration unit 20.

The crushed piece is transported from the crushing unit 12 to the defibration unit 20 by air flow. In addition, the defibrated material MB is transferred from the defibration unit 20 to the selection unit 40 through the tube 3 by air flow. These air flows may be generated by the defibration unit 20 or may be generated by providing a blower (not shown).

The selection unit 40 selects a component included in the defibrated material MB in accordance with sizes of the fibers. The size of the fiber indicates mainly a length of the fiber.

The selection unit 40 of the embodiment includes a drum unit 41, and a housing unit 43 accommodating the drum unit 41. The drum unit 41 is, for example, a so-called sieve such as a net including an opening, a filler, or a screen. Specifically, the drum unit 41 has a cylindrical shape rotatably driven by a motor and at least a part of a peripheral surface is formed of a net. The drum unit 41 may be configured of wire netting, expanded metal obtained by extending a metal plate having a gap or punching metal. The defibrated material MB introduced from an introduction port 42 into the drum unit 41 is divided into a passed material which passes the opening of the drum unit 41 and a residue which does not pass the opening, by the rotation of the drum unit 41. The passed material which has passed the opening includes fibers or particles having a size smaller than the opening, and this is referred to as a first selected material. The residue includes fibers, a non-defibrated piece, or a lump having a size greater than the opening, and this is referred to as a second selected material. The first selected material is dropped into the housing unit 43 towards the first web formation unit 45. The second selected material is transported from an outlet 44 connecting to the inner portion of the drum unit 41 to the defibration unit 20 through a tube 8.

The vibration plate manufacturing device 100 may include a classifier which separates the first selected material and the second selected material from each other, instead of the selection unit 40. The classifier is, for example, a cyclone classifier, Elbow-Jet classifier, or Eddy classifier.

The first web formation unit 45 includes a mesh belt 46, stretching rollers 47, and an suction unit 48. The mesh belt 46 is an endless metal belt and is suspended over a plurality of stretching rollers 47. The mesh belt 46 goes around an orbit made by the stretching rollers 47. A part of the orbit of the mesh belt 46 is planar below the drum unit 41 and the mesh belt 46 configures a planar surface.

A plurality of openings are formed on the mesh belt 46, and components having a larger size than the opening of the mesh belt 46 among the first selected material dropped from the drum unit 41 are accumulated on the mesh belt 46. The components having a smaller size than the opening of the mesh belt 46 among the first selected material pass through the opening. The component having passed through the opening of the mesh belt 46 are referred to as a third selected material, and includes, for example, fibers having a size shorter than the opening of the mesh belt 46, resin particles separated from the fibers by the defibration unit 20, and particles including an ink, a toner, or a bleeding inhibitor.

The suction unit 48 is coupled to a blower (not shown) and the air is sucked by the suction power of the blower below the mesh belt 46. The air sucked from the suction unit 48 is discharged with the third selected material having passed through the opening of the mesh belt 46.

The air flow made by the suction of the suction unit 48 draws the first selected material dropped from the drum unit 41 to the mesh belt 46, and accordingly, an effect of promoting the accumulation is exhibited.

The component accumulated on the mesh belt 46 has a web shape and configures a first web W1. That is, the first web formation unit 45 forms the first web W1 from the first selected material selected by the selection unit 40.

The first web W1 is a component mainly including fibers having a larger size than the opening of the mesh belt 46 among the components included in the first selected material, and is formed in a state of being soft and swollen with a large amount of the air. The first web W1 is transported to the rotator 49 along the movement of the mesh belt 46.

The rotator 49 includes a plurality of plate-shaped blades, and is driven and rotates by a driving unit (not shown) such as a motor or the like. The rotator 49 is disposed on an end portion of the orbit of the mesh belt 46 and contacts with a portion where the first web W1 transported by the mesh belt 46 is protruded from the mesh belt 46. The first web W1 is disentangled by the rotator 49 which collides with the first web W1, becomes a lump of small fibers, and is transported to the mixing unit 50 through a tube 7. A material obtained by dividing of the first web W1 by the rotator 49 is set as the material MC. The material MC is obtained by removing the third selected material from the first selected material described above and the main component is the fiber.

As described above, the selection unit 40 and the first web formation unit 45 have a function of separating the material MC mainly including the fiber from the defibrated material MB, and performs the separation step (Step SA3).

The additive material supply unit 52 is a device which adds the additive material AD to a tube 54 which transports the material MC and performs the addition step (Step SA4).

In the additive material supply unit 52, an additive material cartridge 52a for accumulating the additive material AD is set. The additive material cartridge 52a is a tank for accommodating the additive material AD and may be detachable from the additive material supply unit 52. The additive material supply unit 52 includes an additive material extraction unit 52b which extracts the additive material AD from the additive material cartridge 52a, and an additive material insertion unit 52c which discharges the additive material AD extracted by the additive material extraction unit 52b to a tube 54. The additive material extraction unit 52b includes a feeder which sends the additive material AD to the additive material insertion unit 52c. The additive material insertion unit 52c includes an openable shutter and sends the additive material AD to the tube 54 by opening the shutter.

The mixing unit 50 mixes the material MC and the additive material AD to each other by a mixing blower 56. The mixing unit 50 may include a tube 54 for transporting the material MC and the additive material AD to the mixing blower 56. The mixing unit 50 performs the mixing step (Step SA5).

The mixing blower 56 generates the air flow in the tube 54 linking the tube 7 and the dispersion unit 60, and mixes the material MC and the additive material AD with each other. The mixing blower 56, for example, includes a motor, blades which are driven and rotates by the motor, and a case accommodating the blades. In addition, in addition to the blades generating the air flow, the mixing blower 56 may include a mixer which mixes the material MC and the additive material AD with each other. The mixture mixed by the mixing unit 50 is referred to as a mixture MX, hereinafter. The mixture MX is transported to the dispersion unit 60 and introduced to the dispersion unit 60 by the air flow generated by the mixing blower 56.

The dispersion unit 60 disentangles the fibers of the mixture MX and drops the mixture MX to the second web formation unit 70, while performing the dispersion in the atmosphere. When the additive material AD is fibrous, these fibers are also disentangled by the dispersion unit 60 and dropped to the second web formation unit 70. The process of the dispersion unit 60 corresponds to the sieving step (Step SA6).

The dispersion unit 60 performs the sieving step (Step SA6). The dispersion unit 60 includes a dispersion drum 61 and a housing 63 accommodating the dispersion drum 61. The dispersion drum 61 has, for example, a cylindrical structure configured in the same manner as the drum unit 41, and rotates by a power of a motor (not shown) and functions as a sieve, in the same manner as the drum unit 41. The dispersion drum 61 includes an opening, and the mixture MX disentangled by the rotation of the dispersion drum 61 is dropped from the opening. Accordingly, in an internal space 62 formed in the housing 63, the mixture MX is dropped from the dispersion drum 61. The housing 63 corresponds to a case.

The second web formation unit 70 is disposed below the dispersion drum 61. The second web formation unit 70 includes a mesh belt 72, stretching rollers 74, and a suction mechanism 76.

The mesh belt 72 is configured with an endless metal belt similar to the mesh belt 46 and is suspended over the plurality of stretching rollers 74. The mesh belt 72 moves in a transport direction shown with a reference numeral F1, while going around an orbit configured by the stretching rollers 74. A part of the orbit of the mesh belt 72 is planar below the dispersion drum 61 and the mesh belt 72 configures a planar surface.

A plurality of openings are formed on the mesh belt 72, and components having a size larger than the opening of the mesh belt 72 among the mixture MX dropped from the dispersion drum 61 are accumulated on the mesh belt 72. In addition, the components having a size smaller than the opening of the mesh belt 72 among the mixture MX pass through the opening.

The second web formation unit 70 corresponds to the accumulation unit and performs the accumulation step (Step SA7).

The suction mechanism 76 sucks the air from a side of the mesh belt 72 opposite to the dispersion drum 61, by a suction power of a blower (not shown). The components having passed through the opening of the mesh belt 72 is sucked by the suction mechanism 76. The air flow made by the suction of the suction mechanism 76 draws the mixture MX dropped from the dispersion drum 61 to the mesh belt 72, and accordingly, the accumulation is promoted. The air flow of the suction mechanism 76 forms a down flow in a path where the mixture MX drops from the dispersion drum 61, and an effect of preventing the intertangling of the fibers during the dropping can be expected. The component accumulated on the mesh belt 72 has a web shape and configures the second web W2. The second web W2 corresponds to the web and the accumulated material.

In the transport path of the mesh belt 72, a humidity controlling unit 78 is provided at the downstream from the dispersion unit 60. The humidity controlling unit 78 is a mist type humidifier which supplies mist-like water towards the mesh belt 72, and includes, for example, a tank for storing water or an ultrasonic vibrator for generating mist from the water. The humidity controlling unit 78 controls the humidity of the mixture MX by supplying mist to the mixture MX processed in a shape of the second web W2. Accordingly, the amount of moisture of the mixture MX is adjusted and adsorption or the like of the fibers to the mesh belt 72 due to static electricity is suppressed. In addition, since the humidity of the mixture MX processed by the molding unit 210 is controlled, the effect of suppressing cracks or wrinkles during the process of the molding unit 210 and the effect of improving release properties from the molding dies 211 and 212 are obtained.

The humidity controlling unit 78 may be a vaporizing humidifier. In such a case, the humidity controlling unit 78 sprays humidity-controlled air adjusted to have a high humidity towards the second web W2 or supplies the humidity-controlled air to a space where the second web W2 is transported.

The second web W2 is peeled off from the mesh belt 72 and transported to the pressing unit 82 by the web transport unit 79. The web transport unit 79 includes a mesh belt 79a, rollers 79b, and a suction mechanism 79c. The suction mechanism 79c includes a blower (not shown) and generates upward air flow by a suction power of the blower through the mesh belt 79a. The mesh belt 79a can be configured with an endless metal belt including an opening, in the same manner as the mesh belt 46 and the mesh belt 72. The mesh belt 79a moves by the rotation of the rollers 79b and moves on a revolution orbit. In the web transport unit 79, the second web W2 is separated from the mesh belt 72 and adsorbed to the mesh belt 79a by the suction power of the suction mechanism 79c.

A transport direction of the second web W2 formed in the second web formation unit 70 and the sheet S1 and the cut sheet S11 formed from the second web W2 is shown with a reference numeral F in the drawing.

The pressing unit 82 performs the pressing step (Step SA8). The pressing unit 82 presses the second web W2 at a predetermined nip pressure and adjusts a thickness of the second web W2, to realize a high density of the second web W2, and accordingly the sheet S1 is formed. The pressing unit 82 is configured with a pair of calender rollers 85 and 85. The pressing unit 82 includes a press mechanism of applying the nip pressure to the calender rollers 85 and 85 by oil pressure, or a motor which rotates the calender rollers 85 and 85. The conditions for the pressing of the second web W2 by the pressing unit 82 and a thickness of the processed sheet S1 are as described above.

The cutter 90 is a cutter which cuts the sheet S1 and performs the cutting step (Step SA9). The cutter 90, for example, includes a blade which cuts the sheet S1 in a direction intersecting a transport direction of the sheet S1, and an actuator which drives the blade. The cutter 90 operates the blade by the actuator in accordance with the control of the control device 110, to cut the sheet S1 to have a size to be processed by the molding unit 210. The cutter 90 corresponds to the cutting unit.

The molding unit 210 is disposed at the downstream from the cutter 90 in a transport direction F. The cut sheet S11 is transported from the cutter 90 to the molding unit 210. The molding unit 210 performs the press step (Step SA10). The molding unit 210 is a press processing device which includes a pair of molding dies 211 and 212 and presses the cut sheet S11 pinched between the molding die 211 and the molding die 212.

The molding die 211 and the molding die 212 are press dies fit to each other. The molding die 211 is a male die having a protruded shape and the molding die 212 is a female die having a recessed shape. The molding die 211 and the molding die 212 are fit to each other to press the cut sheet S11, and accordingly, the plate-shaped fiber body CP2 is formed.

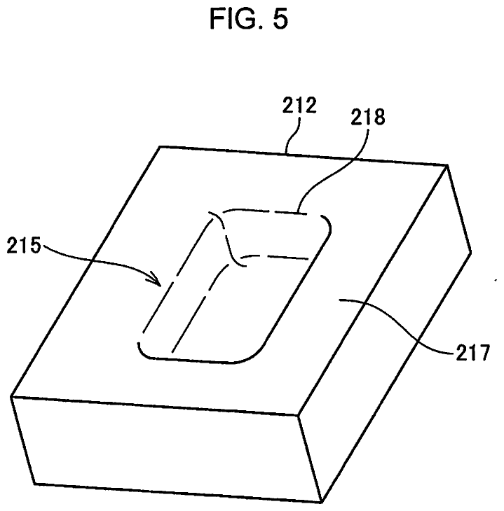

FIG. 5 is a perspective view of the molding die 212.

The molding die 212 includes a recess 215 having a shape of the vibration plate CP1. The recess 215 is formed approximately in the center of a planar surface 217 of the molding die 212. A surface from the planar surface 217 to the recess 215 is a smooth curved surface 218.

The cut sheet S11 is cut by the cutter 90, set on the planar surface 217, and pressed by the molding die 211. Since the cut sheet S11 is a planar sheet, the cut sheet S11 is pressed by the molding die 211 and deformed to be slid into the recess 215.

In the molding die 212, the surface in contact with the cut sheet S11 is preferably a smooth surface, in order to reduce a friction with the fibers 15 included in the cut sheet S11. Particularly, since the curved surface 218 has a great friction with the cut sheet S11, at least the curved surface 218 preferably has a surface roughness which is equal to or smaller than an average fiber width of the fibers 15. In this case, when the cut sheet S11 is pressed by the molding unit 210, the cut sheet is smoothly slid along the recess 215, and accordingly, a possibility of generation of cracks or wrinkles on the plate-shaped fiber body CP2 further decreases. Therefore, it is possible to suppress proportion defective of the plate-shaped fiber body CP2.

The surface roughness of the planar surface 217 is more preferably equal to or smaller than the average fiber width of the fibers 15. The entire surface of the molding die 212 in contact with the cut sheet S11 over the planar surface 217, the curved surface 218, and the recess 215 is even more preferably a surface having a surface roughness equal to or smaller than the average fiber width of the fibers 15.

Also in the molding die 211 fit to the molding die 212, a surface roughness of the surface in contact with the cut sheet S11 is preferably equal to or smaller than the average fiber width of the fibers 15. When the surface roughnesses of both the molding die 211 and the molding die 212 are equal to or smaller than the average fiber width of the fibers 15, it is possible to most effectively suppress wrinkles or cracks on the plate-shaped fiber body CP2.

The heating unit 400 is provided at the downstream from the molding unit 210 in the transport direction F. The heating unit 400 performs the heating step (Step SA11) and heats the plate-shaped fiber body CP2 formed by the molding unit 210. The heating unit 400 accommodates the plate-shaped fiber body CP2 in a housing in which a heater is disposed, and heats the plate-shaped fiber body CP2. The heater of the heating unit 400 may be, for example, an electric heater or may be a heater such as a microwave heating device. In addition, superheated steam may be supplied between the molding dies 211 and 212 to heat the plate-shaped fiber body CP2. A heating temperature of the heating unit 400 is, for example, selected in a range of 130° C. to 200° C., as described above. In the embodiment, the heating unit 400 configures the molding unit with the molding unit 210.

The sheet detection unit 301 is a sensor disposed between the humidity controlling unit 78 and the pressing unit 82. The sheet detection unit 301 detects whether the second web W2 exists, which is transported from the humidity controlling unit 78 to the pressing unit 82. For example, as the sheet detection unit 301, a reflection type or a transmission type light sensor can be used. The sheet detection unit 301 is coupled to the control device 110, and the control device 110 detects whether the second web W2 exists at a detection position of the sheet detection unit 301 and that an edge of the second web W2 has reached the position of the sheet detection unit 301, based on detection values of the sheet detection unit 301.

The rotary encoder 302 is provided between the cutter 90 and the molding unit 210 and detects a transported amount of the cut sheet S11. The rotary encoder 302 includes a roller which is in contact with the cut sheet S11 and rotates in accordance with the transport of the cut sheet S11, and a sensor which detects a rotation rate of the roller. In addition, instead of the rotary encoder 302, a light sensor which detects the transported amount of the cut sheet S11 may be provided.

The control device 110 controls the operation of the vibration plate manufacturing device 100, based on the detection values of the sheet detection unit 301 and the rotary encoder 302. In this control, the control device 110 operates at least a driving device which drives the blade of the cutter 90 at a suitable timing. The control device 110 may have a configuration of controlling a driving device which supplies the raw material MA in the supply unit 10, a driving device which drives the rotor 24 of the defibration unit 20, a driving device which rotates the drum unit 41, a driving device which drives the mesh belt 46, and the like. In addition, the control device 110 may have a configuration of controlling a driving device which rotates the rotator 49, a driving device which drives the additive material extraction unit 52b and the additive material insertion unit 52c of the additive material supply unit 52, a driving device which rotates the mixing blower 56 and the dispersion drum 61, and the like. The control device 110 may have a configuration of controlling a driving device which moves the mesh belt 72, a driving device which presses and rotates the calender roller 85, and the like. The control device 110 may have a configuration of controlling a driving device or the like which performs press in the molding unit 210. The control device 110 may have a configuration of controlling a driving device for the heater of the heating unit 400, a driving device which transports the sheet S1, the cut sheet S11, and the plate-shaped fiber body CP2, and the like. The control device 110 may have a configuration of controlling a blower or various driving devices (not shown in FIG. 4). The driving devices described above are motors or actuators.

1-4. Operation of Vibration Plate Manufacturing Device

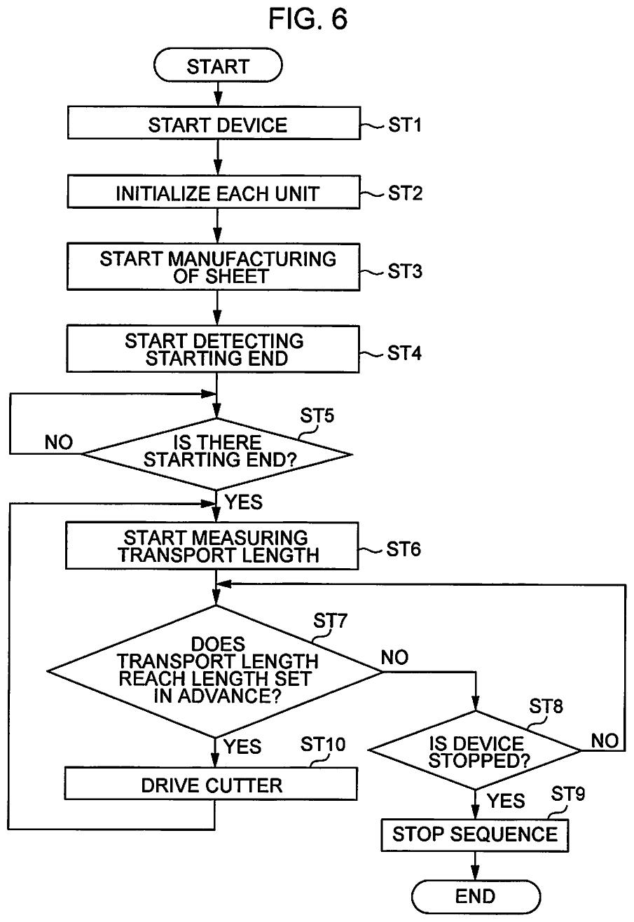

FIG. 6 is a flowchart showing the operation of the vibration plate manufacturing device 100 and shows a control performed by the control device 110.

When the control device 110 detects that an instruction of starting the vibration plate manufacturing device 100 is performed (Step ST1), each unit of the vibration plate manufacturing device 100 is initialized (Step ST2). In Step ST2, the control device 110 initializes the various devices described above, and various sensors including the sheet detection unit 301 and the rotary encoder 302.

The control device 110 instructs each unit of the vibration plate manufacturing device 100 to start the manufacturing of the sheet S1 (Step ST3). The control device 110 starts the operations of the supply unit 10, the defibration unit 20, the selection unit 40, the first web formation unit 45, the rotator 49, the additive material supply unit 52, the mixing blower 56, the dispersion unit 60, the second web formation unit 70 and the humidity controlling unit 78.

The control device 110 obtains detection values of the sheet detection unit 301 and starts the detection of the edge of the sheet S1 based on a change of the detection values (Step ST4).

The control device 110 determines whether or not the sheet detection unit 301 detected the edge of the sheet S1 (Step ST5). The control device 110 is on standby while the sheet detection unit 301 does not detect the edge of the sheet S1 (Step ST5; No). When it is determined that the sheet detection unit 301 detects the edge of the sheet S1 (Step ST5; Yes), the control device 110 starts measurement of a transport length by the rotary encoder 302, that is, the transported amount (Step ST6).

The control device 110 determines whether or not the transport length measured by the rotary encoder 302 reaches the length set in advance (Step ST7). The set length is a length of the cut sheet S11 corresponding to the size of the molding dies 211 and 212 of the molding unit 210 and is stored in the control device 110 in advance. When the measured transport length does not satisfy the set length (Step ST7; No), the control device 110 determines whether or not the vibration plate manufacturing device 100 stops (Step ST8). In Step ST8, the control device 110, for example, determines that it is affirmative, when an operation of instructing stop of the vibration plate manufacturing device 100 is performed on the control device 110, or when the manufacturing of the set number of vibration plates CP1 is completed by the vibration plate manufacturing device 100.

When the vibration plate manufacturing device 100 stops (Step ST8; Yes), the control device 110 performs a stop sequence of the vibration plate manufacturing device 100 (Step ST9), and the process ends.

When the vibration plate manufacturing device 100 does not stop (Step ST8; No), the control device 110 returns to Step ST7.

When the control device 110 determines that the measured transport length reaches the set length (Step ST7; Yes), the cutter 90 is driven to cut the sheet S1 (Step ST10). After that, the control device 110 returns to Step ST6.

By repeatedly performing Steps ST6 to ST8 and ST10, the control device 110 can cut the cut sheet S11 having a length suitable to a processing size of the molding unit 210 from the sheet S1. The length of the cut sheet S11 is a unit amount for performing the press processing by the molding unit 210.

As described above, the vibration plate manufacturing device 100 of the first embodiment molds the vibration plate CP1. The vibration plate CP1 includes the defibrated material MB obtained by the defibration of the raw material MA including the fibers 15, and the resin 16 as the binding material for binding the fibers to each other, and is a fiber molded product three-dimensionally molded by a molding process including pressing and heating.

In the vibration plate CP1, the resin 16 is added to the defibrated material MB obtained by defibration of the material, and accordingly, deviation or aggregation of the fibers 15 and the resins 16 is suppressed and the fibers 15 and the resins 16 are homogeneously distributed. The vibration plate CP1 has a configuration in which the fibers 15 are homogeneously distributed, crosslinked, and bound to each other by the resins 16. Regarding the mixture of the fibers 15 and the resins 16, the strength is increased, and a stable shape is maintained, due to the crosslinking of the resins 16 and the fibers 15 due to the heating. Accordingly, by mixing the defibrated fibers 15 and the dispersed resins 16, that is, by a so-called dry type manufacturing method, it is possible to obtain a fiber molded product having high homogeneity.

The fiber 15 is preferably a fiber having a fibril area of 0.5% to 2.0%. By using the fiber 15 having a small fibril area, the fibers 15 are in a state of being easily moved, in the press step by the molding unit 210 for the three-dimensional molding. Accordingly, it is possible to suppress generation of wrinkles or cracks during the processing of the molding unit 210. The press processing by the molding unit 210 is suitable for the manufacturing of the fiber molded product having various shapes, regardless of the shape of the vibration plate CP1 shown in FIG. 1. Therefore, the vibration plate manufacturing device 100 can manufacture the fiber molded product having various shapes by processing the fibers 15, and it is possible to efficiently suppress wrinkles or cracks during the manufacturing.

The vibration plate manufacturing device 100 includes the defibration unit 20 which defibrates the material including fibers and generates the defibrated material MB formed of fibers having a fibril area of 0.5% to 2.0%, and the mixing unit 50 which mixes the resin 16 for binding the fibers to each other, with the defibrated material MB. The vibration plate manufacturing device 100 includes the second web formation unit 70 as the accumulation unit which accumulates the mixture obtained by mixing by the mixing unit 50. The vibration plate manufacturing device 100 includes the molding unit 210 and the heating unit 400 which obtain the molded product by performing the molding process including pressing and heating on the second web W2 accumulated by the second web formation unit 70.

The vibration plate manufacturing device 100 manufactures the vibration plate CP1 in a so-called dry type process of dispersing the mixture MX in the atmosphere and accumulating. As a method of molding the material including fibers, the papermaking of dispersing the fibers in a liquid, as described above, has been known, as a contrasting method with that of the vibration plate manufacturing device 100. Specifically, this is a so-called wet type papermaking of performing the papermaking and molding by dispersing fibers such as pulp. The wet type papermaking is a molding method using a hydrogen bond between fibers. In this method, the hydrogen bond between fibers strongly works due to the use of water, and it is difficult to ensure a long distance between fibers. Accordingly, a density of the fibers after the molding is high, and it is difficult to manufacture a molded product having a low density. In addition, since the wet papermaking uses a large amount of water, it is necessary to provide equipment for water supply and drainage. In this regard, according to the embodiment, it is possible to obtain the vibration plate CP1 having a fiber structure having a high homogeneity, by the dry process with which aggregation or deviation of the fibers 15 and the resins 16 is hardly generated.

The fiber molded product manufactured by the vibration plate manufacturing device 100 can be used for various uses, and, for example, the vibration plate CP1 is suitable as a speaker vibration plate. The homogeneity is necessary for a speaker vibration plate, in order to obtain excellent sound quality. When the material other than the fiber, such as the additive material AD of the embodiment, is added, it is desirable that the material to be added is evenly present in the plane, without deviation in the structure of the vibration plate. In the wet papermaking, a plurality of materials are dispersed in water. Thus, deviation or aggregation may occur due to a difference in shape, a specific gravity, hydrophilicity and hydrophobicity, solubility, and dispersibility of the materials. Accordingly, unevenness of components or unevenness of a thickness may occur during the wet papermaking.

It is known that it is necessary to realize a low density, a high rigidity, and a high internal loss, as the properties of the speaker vibration plate, in order to obtain excellent sound quality.

According to the vibration plate manufacturing device 100 of the embodiment, a method of dispersing and accumulating the mixture MX including fibers defibrated by the dry method by the defibration unit 20, in the atmosphere is used. Therefore, it is possible to manufacture the vibration plate CP1 having a low density, a high rigidity, and a high internal loss.

As described above, according to the vibration plate manufacturing device 100, to which the fiber molding device and the manufacturing method of the fiber molding device of the present disclosure are applied, it is possible to manufacture the vibration plate CP1 having a fiber structure having a high homogeneity by a method by which wrinkles or cracks are hardly generated.

IN addition, the resin 16 of the vibration plate CP1 is a thermoplastic resin. Accordingly, it is possible to easily realize the configuration in which the fibers 15 are crosslinked by the resins 16, by the process including heating.

The molding unit 210 has a configuration of pressing the cut sheet S11 pinched between the molding dies 211 and 212, and accordingly, the setting of the cut sheet S11 on the molding unit 210 and the press process are easily performed. Therefore, it is possible to efficiently manufacture the vibration plate CP1.

The surface roughness of at least any of the molding die 211 and the molding die 212 of the molding unit 210 can be configured to be equal to or smaller than the average fiber width of the fibers included in the defibrated material MB. In such a case, it is possible to suppress generation of wrinkles or cracks on the cut sheet S11 during the processing of the molding unit 210.

The molding unit 210 performs the heating at a temperature equal to or higher than the glass transition temperature of the resin 16. Accordingly, it is possible to reliably crosslink the fibers 15 by the resins 16 and obtain the vibration plate CP1 having an excellent strength.

The molding unit 210 may perform the heating at a temperature equal to or higher than the glass transition temperature of the resin 16 and equal to or lower than the melting point of the resin 16. In this case, the resin 16 is not completely dissolved, and accordingly, in the plate-shaped fiber body CP2, it is possible to realize a strength by having a space between fibers 15, crosslinking the fibers 15 in a bulky state, and fixing the fibers 15. Therefore, it is possible to obtain the vibration plate CP1 having a light weight and excellent strength.

In the vibration plate manufacturing device 100, since the humidity of the second web W2 obtained by processing the mixture MX in a web shape is controlled by the humidity controlling unit 78, it is possible to ensure the release properties of the second web W2 or the cut sheet S11 in the pressing unit 82 and the molding unit 210.

The vibration plate manufacturing device 100 includes the cutter 90 which cuts the second web W2 transported to the molding unit 210 at a position upstream from the molding unit 210 in the transport direction of the second web W2. In addition, the vibration plate manufacturing device 100 includes the control device 110 which detects the transported amount of the second web W2 transported to the molding unit 210 by the rotary encoder 302, and operates the cutting unit based on the transported amount and the unit amount of the molding process of the molding unit 210. Accordingly, it is possible to set to the molding unit 210 and perform the press process on the cut sheet S11 having a size suitable for the processing of the molding unit 210. The process of the molding unit 210 does not affect the sheet S1 disposed at the upstream side thereof, and accordingly, it is possible to increase a degree of freedom of a shape to be processed by the molding unit 210 and easily manufacture various fiber molded products, without limitation to the vibration plate CP1.

### 2. Second Embodiment

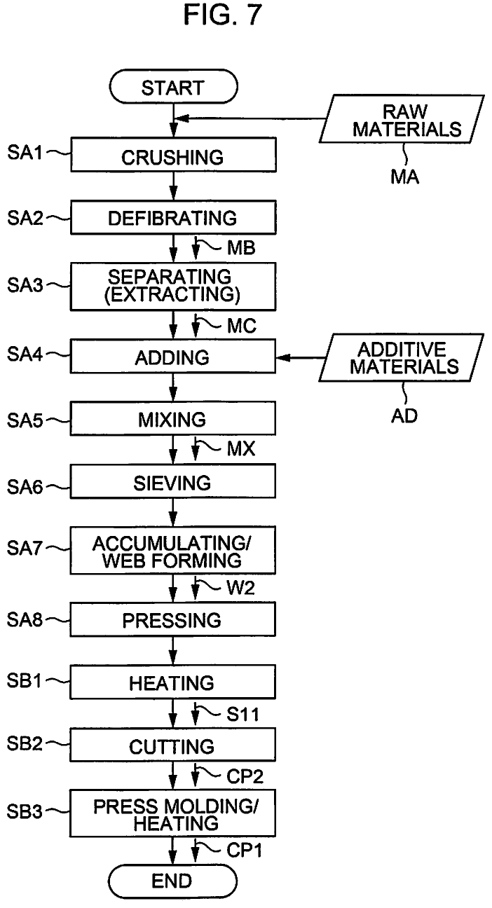

FIG. 7 is a flowchart showing a manufacturing method of the vibration plate CP1 of a second embodiment.

In a manufacturing step of the vibration plate CP1 of the second embodiment, the second web W2 is pressed in Step SA8 to form the sheet S1, the heating step (Step SB1) is performed, and the pressing and heating were performed in the press molding step (Step SB3). Accordingly, the heating is performed twice. In the manufacturing step of the vibration plate CP1 of the second embodiment, Steps SA1 to SA7 are the same as those in the manufacturing method described in the first embodiment, and therefore, the description is omitted.

In the heating step in Step SB1, the sheet S1 formed in the pressing step is heated. In the cutting step in Step SB2, the heated sheet S1 is cut to have a size of the molding die to form the cut sheet S11.

In the press molding step in Step SB3, the cut sheet S11 is pressed by being pinched between the molding dies 211 and 212, and the cut sheet S11 is heated with the molding dies 211 and 212.

The heating temperature of the heating step (Step SB1) is lower than the heating temperature of the press molding step (Step SB3).

For example, in the heating step (Step SB1), the sheet S1 is heated at a temperature of 100° C. to 180° C., and in the press molding step (Step SB3), the cut sheet S11 is heated at a temperature of 130° C. to 200° C. In addition, in both of the heating step (Step SB1) and the press molding step (Step SB3), the heating temperature is preferably equal to or higher than the glass transition temperature Tg of the resin 16 and equal to or lower than the melting point of the resin 16.

In addition, the pressure applied to the cut sheet S11 in the press molding step (Step SB3) is preferably a pressure higher than the pressure applied to the second web W2 in the pressing step (Step SA8). For example, the pressure in the pressing step can be 0.1 kg/m² to 100 kg/m². The second web W2 is processed into the sheet S1 having a thickness of 1 mm to 10 mm in the pressing step, for example. Meanwhile, the pressure in Press molding step (Step SB3) can be 0.1 t/m² to 15 t/m². In the press molding step, the cut sheet S11 is processed into the vibration plate CP1 having a thickness of 0.1 mm to 5 mm, for example.

That is, in the pressing step (Step SA8), the pressing with a pressure lower than that in the press molding step (Step SB3) is performed, and in the heating step (Step SB1), the heating at a temperature lower than that in the press molding step (Step SB3) is performed. Accordingly, the pressing step (Step SA8) and the heating step (Step SB1) can be a temporary binding step of temporarily binding the fibers 15 by the resins 16, compared with the press molding step (Step SB3).

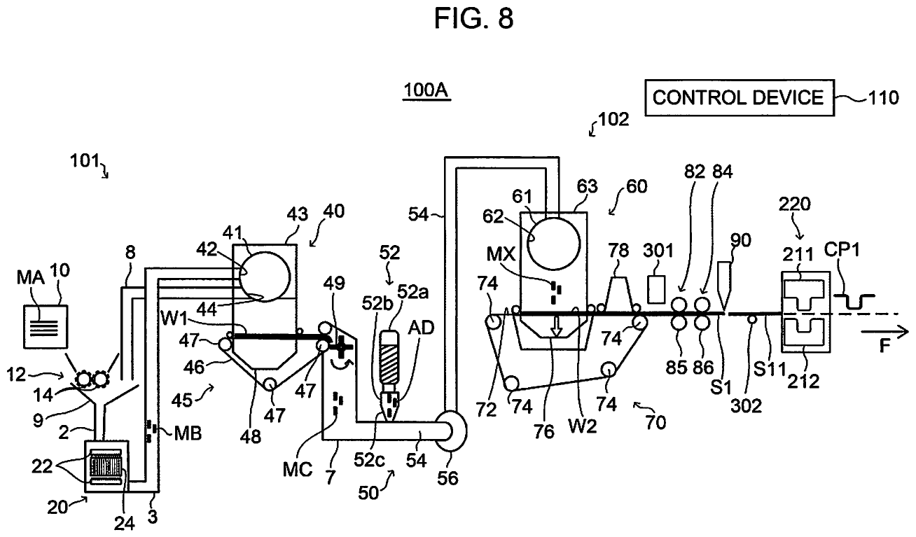

FIG. 8 is a configuration view of a vibration plate manufacturing device 100A of the second embodiment.

The vibration plate manufacturing device 100A is an example of a device which performs the manufacturing method of FIG. 7. The vibration plate manufacturing device 100A has a configuration in which a heating unit 84 is provided on the vibration plate manufacturing device 100 shown in FIG. 4, a molding unit 220 is provided instead of the molding unit 210, and a heating unit 400 is not included. In the vibration plate manufacturing device 100A, the same reference numerals are used for the common configuration units with the vibration plate manufacturing device 100, and therefore, the description thereof is omitted. The vibration plate manufacturing device 100A corresponds to the fiber molding device.

The heating unit 84 performs the heating step (Step SB1). The heating unit 84 applies heat to the second web W2 to bind the material MC-derived fibers 15 included in the second web W2 by the resin 16 included in the additive material AD. The heating unit 84 includes a pair of heating rollers 86 and 86. The heating unit 84 includes a heater (not shown) which heats peripheral surfaces of the heating rollers 86 to a predetermined temperature, and a motor (not shown) which rotates the heating rollers 86 and 86 towards the cutter 90. The second web W2 is heated to a higher temperature than a glass transition temperature of the resin included in the mixture MX in the heating unit 84 and is set as the sheet S1.

The cutter 90 performs the cutting step (Step SB2) and cuts the sheet S1 heated by the heating unit 84 to form the cut sheet S11.

The molding unit 220 performs the press molding step (Step SB3). The molding unit 220 includes the same molding dies 211 and molding die 212 as those of the molding unit 210. In addition, after pressing or during pressing the sheet S11 by the molding dies 211 and the molding dies 212, the molding unit 220 heats the cut sheet S11. For example, the molding unit 220 includes a chamber which accommodates the molding dies 211 and 212 with the cut sheet S11, and heats the inside of the chamber with a heater. The heater of the molding unit 220 may be an electric heater or a heater of a microwave heating device. In addition, superheated steam may be supplied between the molding dies 211 and 212 to heat the cut sheet S11.

The vibration plate manufacturing device 100A includes the pressing unit 82 and the heating unit 84, as the sheet molding unit which presses and heats the second web W2 accumulated by the second web formation unit 70 which is the accumulation unit, to form the sheet S1. The molding unit 220 performs the molding process including the heating at a higher temperature than that of the heating unit 84, on the cut sheet S11 cut from the sheet S1. In this configuration, in the heating step (Step SB1) which is the temporary binding step, the fiber 15 and the fiber 15 are crosslinked to each other and the fibers 15 are bound to each other by heating the resins 16. In the press molding step (Step SB3), by heating the cut sheet S11 in which the strength is realized by the crosslinking of the fibers 15, the cut sheet S11 is softened in the molding unit 220. When the molding unit 220 presses the cut sheet S11, the cut sheet S11 is in a soft state, and accordingly, the processing is easily performed, and it is possible to suppress generation of wrinkles or cracks during the processing.

### 3. Third Embodiment

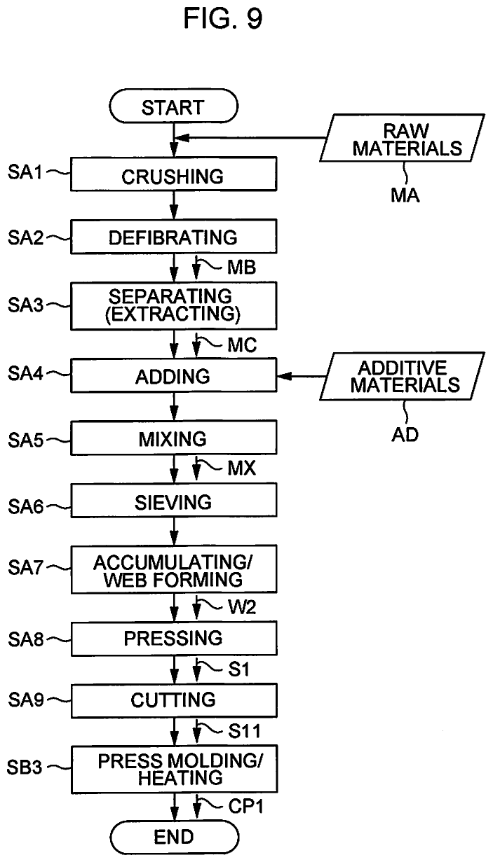

FIG. 9 is a flowchart showing a manufacturing method of the vibration plate of a third embodiment.

In a manufacturing step of the vibration plate CP1 of the third embodiment, the press molding step (Step SB3) is performed, instead of the press step (Step SA10) and the heating step (Step SA11) of the manufacturing step described in the first embodiment. In the manufacturing step of the vibration plate CP1 of the third embodiment, Steps SA1 to SA9 are the same as those in the manufacturing method described in the first embodiment, and therefore, the description is omitted.

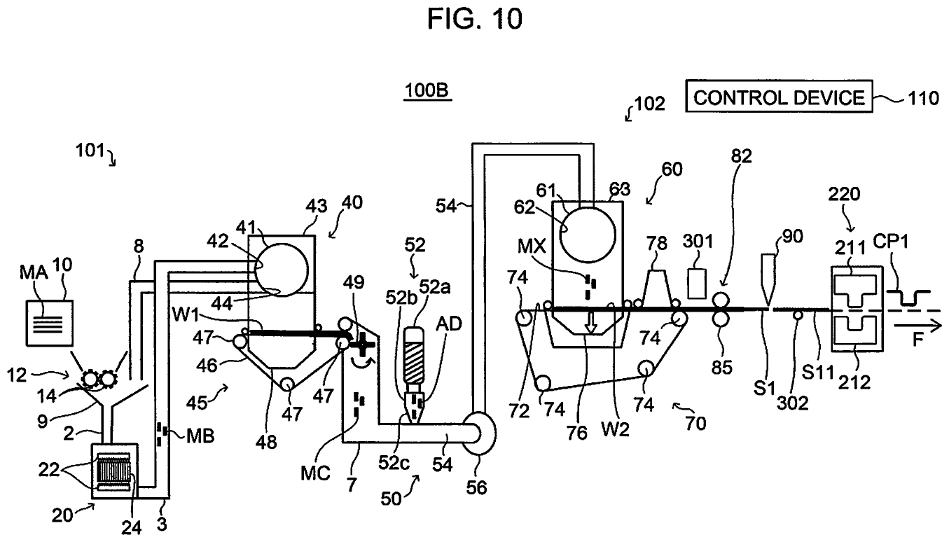

FIG. 10 is a configuration view of a vibration plate manufacturing device 100B of the third embodiment.

The vibration plate manufacturing device 100B is an example of a device which performs the manufacturing method of FIG. 9. The vibration plate manufacturing device 100B has a configuration in which the molding unit 210 and the heating unit 400 of the vibration plate manufacturing device 100 shown in FIG. 4 are not included, and the molding unit 220 shown in FIG. 8 is provided. In the vibration plate manufacturing device 100B, the same reference numerals are used for the common configuration units with the vibration plate manufacturing device 100, and therefore, the description thereof is omitted. The vibration plate manufacturing device 100B corresponds to the fiber molding device.

The vibration plate manufacturing device 100B sets the cut sheet S11 cut by the cutter 90 on the molding unit 220, performing the molding step (Step S83) by the molding unit 220, and performs the pressing and heating. In the vibration plate manufacturing device 100B, one heating is performed in the press molding step. In the vibration plate manufacturing device 100B, the vibration plate CP1 is manufactured through substantially the same step as that in the vibration plate manufacturing device 100. In addition, by providing the molding unit 220 instead of the molding unit 210 and the heating unit 400, it is possible to perform the pressing and the heating at the same time, and omit the step according to the transport of the plate-shaped fiber body CP2. Therefore, it is possible to realize a miniaturization of the device or improvement of manufacturing efficiency.

### 4. Example

The inventors have conducted comparison studies regarding the fibril area of the fiber 15.

In the example, the vibration plate CP1 was manufactured by the vibration plate manufacturing device 100 described in the first embodiment, and a study regarding a generation state of the wrinkles and cracks of the vibration plate CP1 was conducted.

In the example, a sample fiber having an adjusted fibril area was used as the material MC. The sample fiber is a fiber having a fibril area adjusted to 0.3% to 2.4%, as will be described later. In the adjustment of the fibril area of the sample fiber, the fibril area can be changed by adjusting a defibration time of the defibration unit 20, that is, a retention time of the defibration unit 20. Specifically, when the defibration time of the defibration unit 20 (retention time of the defibration unit 20) is long, the fiber is more finely crushed, and accordingly, the fibril area decreases. On the other hand, when the defibration time of the defibration unit 20 (retention time of the defibration unit 20) is short, the fibril area increases. Accordingly, by adjusting the defibration unit 20 (retention time of the defibration unit 20), it is possible to obtain the defibrated material MB including the fibers 15 having a fibril area of 0.5% to 2.0% as a main component, as described above. The sample fiber was used, for the study of an example including fibers having the fibril area different from the defibrated material MB. The fibril area of each example is a value measured in the measurement item of “Fibre area” by “L&W fiber tester Code 912+” manufactured by ABB.

As an example of the fibers having different fibril areas, fibers having a fibril area of 0.3%, 0.5%, 0.8%, 1.0%, 1.2%, 1.4%, 1.6%, 1.8%, 2.0%, 2.2%, and 2.4% were used. The vibration plate CP1 was manufactured by the vibration plate manufacturing device 100 using these fibers, and it was visually determined whether wrinkles and cracks exist during the process of the molding unit 210.

As the common condition in each example, in the additive material AD, particles of a polycarbonate resin was used as the resin 16. The heating temperature of the heating unit 400 was set as 180° C. Since the glass transition temperature Tg of polycarbonate is 150° C. and the melting point is 250° C., the heating temperature of the heating unit 400 is equal to or higher than the glass transition temperature Tg and equal to or lower than the melting point. The pressure of the pressing unit 82 was set as 10 kg/m², and the pressure of the molding unit 210 was set as 1 t/m².

The results thereof are shown in Table. In the determined results shown in Table, a case where the generation of wrinkles is confirmed is shown as “Poor”, and a case where the generation of wrinkles is not confirmed is shown as “Good”. In addition, a case where the generation of cracks is confirmed is shown as “Poor”, and a case where the generation of cracks is not confirmed is shown as “Good”. Therefore, the vibration plate CP1 in which any of wrinkles and cracks is not generated is a fine product, and the vibration plate CP1 in which any of wrinkles and cracks was determined as “Poor” is a defective product.

TABLE

| | Fibril area | Determination | Determination |
|---|---|---|---|
| No. | (%) | (wrinkles) | (cracks) |
| 1 | 0.3 | Good | Poor |
| 2 | 0.5 | Good | Good |
| 3 | 0.8 | Good | Good |
| 4 | 1.0 | Good | Good |
| 5 | 1.2 | Good | Good |
| 6 | 1.4 | Good | Good |
| 7 | 1.6 | Good | Good |
| 8 | 1.8 | Good | Good |
| 9 | 2.0 | Good | Good |
| 10 | 2.2 | Poor | Good |
| 11 | 2.4 | Poor | Poor |

As shown in Table, in the example where the fibril area was set as 0.3%, cracks were generated, and in the example where the fibril area was set as 2.2%, wrinkles were generated. In the example where the fibril area was set as 2.4%, wrinkles and cracks were generated.

From the results described above, the fibril area of the fibers configuring the vibration plate CP1 is suitably 0.5% to 2.0%.

### 5. Other Embodiment

Each embodiment is merely specific aspects for performing the present disclosure disclosed in the aspects, and the disclosure is not limited thereto. The present disclosure can be performed in various aspects as shown below, for example, within a range not departing from a gist thereof.

For example, when the vibration plate CP1 shown as an example of the fiber molded product of each embodiment is a speaker vibration plate, the vibration plate may include ribs or may have other three-dimensional shapes. A color or properties of the vibration plate CP1 is random, and for example, by causing the additive material AD to include a colorant together with the resin, the material MC may be colored, and the vibration plate CP1 may be manufactured by using the mixture MX in any color.

For other specific configurations, the modification can be randomly performed.

What is claimed is:

1. A fiber molded product, comprising:
a defibrated material obtained by defibrating a material including fibers; and
a binding material for binding the fibers to each other, wherein
the fiber molded product is three-dimensionally molded by a molding process including pressing and heating, and
the defibrated material is formed of fibers having a fibril area of 0.5% to 2.0%.

2. The fiber molded product according to claim 1, wherein
the binding material includes a thermoplastic resin.

3. A fiber molding device comprising:
a defibration unit which defibrates a material including fibers and generates a defibrated material formed of fibers having a fibril area of 0.5% to 2.0%;
a mixing unit which mixes a binding material for binding the fibers to each other, into the defibrated material;
an accumulation unit which accumulates a mixture mixed by the mixing unit; and
a molding unit which performs a molding process including pressing and heating on an accumulated material accumulated by the accumulation unit to obtain a molded product.

4. The fiber molding device according to claim 3, wherein
the binding material includes a thermoplastic resin.

5. The fiber molding device according to claim 3, wherein
the molding unit presses the accumulated material pinched using a press die.

6. The fiber molding device according to claim 5, wherein
a surface roughness of the press die is equal to or smaller than an average fiber width of the fibers included in the defibrated material.

7. The fiber molding device according to claim 3, wherein
the molding unit performs the heating at a temperature equal to or higher than a glass transition temperature of the binding material.

8. The fiber molding device according to claim 7, wherein
the molding unit performs the heating at the temperature equal to or higher than the glass transition temperature of the binding material and equal to or lower than a melting point of the binding material.

9. The fiber molding device according to claim 3, further comprising
a humidity controlling unit which controls humidity of the mixture.

10. The fiber molding device according to claim 3, further comprising
a sheet molding unit which presses and heats the accumulated material accumulated by the accumulation unit to form a sheet, wherein
the molding unit performs on the sheet the molding process including heating at a temperature higher than that in the sheet molding unit.

11. The fiber molding device according to claim 3, further comprising:
a cutting unit which cuts the accumulated material to be transported to the molding unit at a position upstream from the molding unit in a transport direction of the accumulated material; and
a control device which detects a transported amount of the accumulated material to be transported to the molding unit, and operates the cutting unit based on the transported amount and a unit amount of the molding process of the molding unit.

12. A manufacturing method of a fiber molded product, the method comprising:
defibrating a material including fibers to generate a defibrated material formed of fibers having a fibril area of 0.5% to 2.0%;
mixing a binding material for binding the fibers to each other, into the defibrated material;
accumulating the mixture; and
performing a molding process including pressing and heating on the accumulated material to obtain a molded product.
